(19) United States
(12) Patent Application Publication
(10) Pub. No.: US 2002/0101689 A1
(43) Pub. Date: Aug. 1, 2002

(54) High sensitivity spin valve stacks using oxygen in spacer layer deposition

(76) Inventors: Xuefei Tang, Eden Prairie, MN (US); Song Sheng Xue, San Jose, CA (US); Steven Paul Bozeman, Savage, MN (US); Qing He, Bloomington, MN (US); Patrick Joseph Ryan, St. Paul, MN (US)

Correspondence Address: MERCHANT & GOULD PC, P.O. BOX 2903, MINNEAPOLIS, MN, 55402-0903, US

(21) Appl. No.: 09/809,651

(22) Filed: Mar. 15, 2001

Related U.S. Application Data
(60) Provisional application No. 60/194,788, filed on Apr. 5, 2000.

(51) Int. Cl. G11B 5/39

(52) U.S. Cl. 360/314; 360/324.1

(57) ABSTRACT

The invention includes methods of manufacturing improved spin valve sensors and the resulting sensors. The method includes the step of depositing a spacer layer in an environment containing oxygen. Preferably, the spacer layer is deposited in an environment containing argon and from about 0.5 to 25,000 ppm oxygen. Spin valve sensors of the invention have a spacer layer containing a non-magnetic electrically conductive material and oxygen. Spin valve sensors of the invention can be dual spin valves, bottom pinned spin valves or top pinned spin valves.

### FIELD OF THE INVENTION

This invention relates generally to magnetic transducers for reading information from a magnetic medium and, in particular, to improved processes using oxygen during fabrication of spin valve magnetoresistive read sensors to decrease interlayer coupling and increase device sensitivity.

### BACKGROUND OF THE INVENTION

Computers often include auxiliary memory storage devices having media on which data can be written and from which data can be read for later use. A direct access storage device (disk drive) incorporating rotating magnetic disks is commonly used for storing data in magnetic form on the disk surfaces. Data is recorded on concentric, radially spaced tracks on the disk surfaces. Magnetic heads including read sensors are then used to read data from the tracks on the disk surfaces.

In high capacity disk drives, magnetoresistive read sensors, commonly referred to as MR heads, are the prevailing read sensors because of their capability to read data from a surface of a disk at greater linear densities than thin film inductive heads. An MR sensor detects a magnetic field through the change in the resistance of its MR sensing layer (also referred to as an “MR element”) as a function of the strength and direction of the magnetic flux being sensed by the MR layer.

One type of MR sensor currently under development is the giant magnetoresistive (GMR) sensor manifesting the GMR effect. In the GMR sensors, the resistance of the MR sensing layer varies as a function of the spin-dependent transmission of the conduction electrons between the magnetic layers separated by a non-magnetic layer (spacer) and the accompanying spin-dependent scattering, which takes place at the interface of the magnetic and non-magnetic layers and within the magnetic layers.

GMR sensors using only two layers of ferromagnetic material (e.g., Ni—Fe or Co or Ni—Fe/Co) separated by a layer of non-magnetic metallic material (e.g., copper) are generally referred to as spin valve (SV) sensors manifesting the SV effect. In an SV sensor, one of the ferromagnetic layers, referred to as the pinned layer, has its magnetization typically pinned by exchange coupling with an antiferromagnetic (e.g., Fe—Mn or NiO) layer. The pinning field generated by the antiferromagnetic layer should be greater than demagnetizing fields to ensure that the magnetization direction of the pinned layer remains fixed during the application of external fields (e.g., fields from bits recorded on the disk). The magnetization of the other ferromagnetic layer, referred to as the free layer, however, is not fixed and is free to rotate in response to the field from the disk.

In order to develop spin valves that have higher sensitivity and the ability to detect lower magnetic fields, the GMR effect of the spin valve has to be increased. One method of increasing the GMR of spin valves is disclosed in W. F. Egelhoff, et al., J Appl. Phys. 82 (12) 6142 (1997) (“Egelhoff”). The method of Egelhoff modifies a common method of fabricating spin valves to increase the giant magnetoresistance of spin valves. Egelhoff introduces oxygen into the chamber during growth of the spin valve layers, which was found to increase the GMR of the spin valves.

Although the method of Egelhoff increases the GMR of the spin valve, oxygen can be detrimental when other or all components of the spin valve are exposed to it. As a result, there is a need for a method of fabricating spin valves that increases the GMR effect but is not detrimental to the spin valve device as a whole.

### SUMMARY OF THE INVENTION

The invention offers a method of manufacturing a spin valve sensor including the steps of depositing an antiferromagnetic material (AFM) on a substrate to form an AFM layer, depositing a ferromagnetic pinned layer on the AFM layer, depositing a non-magnetic electrically conductive material on the pinned layer to form a spacer layer in an environment including oxygen gas, and depositing a ferromagnetic free layer on the spacer layer.

The invention also includes bottom pinned spin valves, top pinned spin valves, and dual spin valves resulting from the method above. Spin valve sensors having a spacer layer that includes a non-magnetic electrically conductive material and oxygen are also included in the invention.

By using a mixture of argon and oxygen gas during deposition of the copper spacer layer, the resulting sensors possess high sensitivity with good soft magnetic properties. Compared to dual spin valve (DSV) sensors fabricated without argon/oxygen mixture gas, the interlayer coupling field of spin valves in accordance with the invention is reduced from about 30 Oe-40 Oe to about 0 Oe. This also results in an increase in the sensitivity of the DSV of more than 250% and a corresponding increase of more than 5% of the DR/R.

For bottom pinned spin valve (BSV) sensors without argon/oxygen mixture gas, the interlayer coupling field of the invention is reduced from about 15 Oe-20 Oe to about 5 Oe, the sensitivity is increased by more than 75%, and the DR/R is increased by more than 3%.

The argon/oxygen mixture gas can be used in the deposition of copper (Cu) or copper alloy spacer layers of spin valves with different antiferromagnetic (AFM) materials, such as PtMn, NiMn, IrMn, PdPtMn, CrMnPt, CrMnCu, CrMnPd, PtRuMn, NiO, and FeO to increase the sensitivity and to reduce the interlayer coupling field of the sensor. Both DR and DR/R of the spin valves can be increased because thinner copper spacer layers may also be used. Generally deposition of all layers of the spin valve is completed in the presence of a noble gas such as argon. Further deposition of all layers, aside from the spacer and free layers, of the spin valve is completed in an environment which is free of oxygen.

### BRIEF DESCRIPTION OF THE DRAWINGS

FIG. 1 depicts a vertical cross section of a dual spin valve in accordance with the invention.

FIG. 2 depicts a vertical cross section of a dual spin valve in accordance with another aspect of the invention.

FIG. 3 depicts a bottom pinned spin valve (BSV) in accordance with one aspect of the invention.

FIG. 4 depicts a top pinned spin valve (TSV) in accordance with one aspect of the invention.

FIG. 5 illustrates the effect of oxygen partial pressure during deposition of the spacer layer of a dual spin valve (DSV) on DR/R and interlayer coupling.

FIG. 6 illustrates the effect of the thickness of the copper spacer layer of a dual spin valve (DSV) on DR/R and interlayer coupling.

FIG. 7 illustrates DR/R of a dual spin valve (DSV) manufactured without oxygen present during spacer layer deposition as the applied field (oriented parallel to the pinning field direction) is varied.

FIG. 8 illustrates DR/R of a dual spin valve (DSV) manufactured without oxygen present during spacer layer deposition as the applied field (oriented perpendicular to the pinning field direction) is varied.

FIG. 9 illustrates DR/R of a dual spin valve (DSV) manufactured with oxygen present during spacer layer deposition as the applied field (oriented parallel to the pinning field direction) is varied.

FIG. 10 illustrates DR/R of a dual spin valve (DSV) manufactured with oxygen present during spacer layer deposition as the applied field (oriented perpendicular to the pinning field direction) is varied.

FIG. 11 illustrates DR/R of a bottom pinned spin valve (BSV) manufactured without oxygen present during spacer layer deposition as the applied field (oriented parallel to the pinning field direction) is varied.

FIG. 12 illustrates DR/R of a bottom pinned spin valve (BSV) manufactured without oxygen present during spacer layer deposition as the applied field (oriented. perpendicular to the pinning field direction) is varied.

### DETAILED DESCRIPTION OF THE PREFERRED EMBODIMENTS

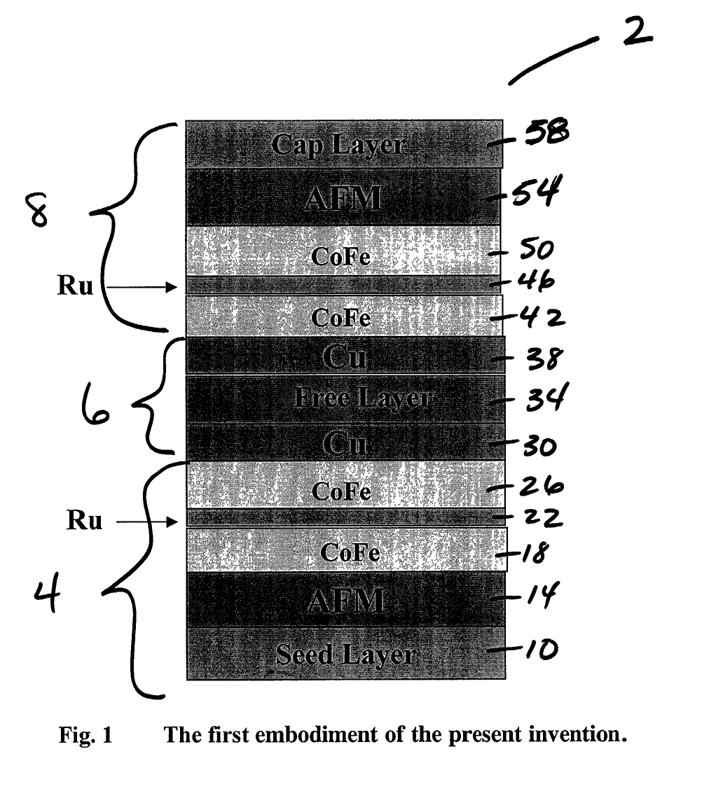

In accordance with the invention, there is provided a method of fabricating various electromagnetic components, which may be used to read information from magnetic information storage media as well as the components resulting from these methods. One embodiment of the invention may be seen in FIG. 1. Generally the components of the invention are referred to as a spin valve. A spin valve is an electromagnetic component used in computer disk drives.

As can be seen, FIG. 1, one embodiment of the spin valve or stack 2 of the invention comprises multiple layers of ferromagnetic and antiferromagnetic materials. Generally, this embodiment of the invention is separated into a lower 4, intermediate 6, and top 8 portions.

Turning first to the lower portion 4 of the stack 2, the lower layer 10 of the stack 2 functions to seed the deposition of the other layers that are subsequently deposited on the stack 2. To this end, the seed layer 10 functions as a substrate and provides structural or textural orientation to the layers deposited subsequently. Generally the seed layer 10 may comprise one or more layers and may comprise any metal or metal alloy. Exemplary metals include nickel (Ni), chromium (Cr), tantalum (Ta), titanium (Ti), manganese (Mu), copper (Cu), tungsten (W), platinum (Pt), gold (Au), silver (Ag) or alloys of these metals.

Generally, the thickness of the seed layer may range from about 30 to 100 angstroms and preferably is about 50 angstroms in single or multiple layers. Seed layer 10 is preferably a bi-layer with a first layer of nickel, iron, chrome in the ratio of 48:12:40, and a second layer of nickel, iron with a ratio of 85:15. The resulting surface orientation of the seed layer 10 is characterized as 111. All layers deposited in the method are generally deposited with commonly accepted sputter deposition methods begun under high vacuum (about 10⁻⁸ Torr) with introduction of a noble gas (at about 0.5 to 20 mTorr) upon beginning the deposition. Preferably, the noble gas is argon (Ar) and it is introduced at about 2 mTorr.

Layer 14 is regarded as an antiferromagnetic layer, or AFM layer, which functions to set the magnetic orientation of the lower portion 4 of the stack 2. Generally, layer 14 is a metal oxide or metal alloy of platinum, manganese, nickel, chromium, iridium, rhodium, paladium, copper, ruthenium, and iron among other metals. Preferably, the antiferromagnetic layer comprises an alloy of platinum and manganese in a ratio of 50:50 with the exact ratio depending on the deposition system. The antiferromagnetic layer is sputter deposited to a thickness of about 50 to 300 angstroms, preferably about 150 angstroms. Sputter deposition is undertaken using standard conditions, as illustrated above, to develop the desired thickness in layer 14.

Pinned layer 18 functions to provide a fixed magnetic orientation to the lower portion 4 of the stack 2 and acts along with reference layer 26 to provide a fixed orientation to the spin valve stack 2. The magnetic orientation of the pinned layer 18 is fixed, (or pinned), by the antiferromagnetic layer 14. Generally, the pinned layer 18 may comprise any number of highly magnetic metals or metal alloys such as cobalt, iron, nickel, chromium, platinum, or tantalum among others. Preferably, pinned layer 18 comprises an alloy of cobalt and iron at a preferred ratio of about 90:10. The pinned layer 18 may be sputter deposited through processes known in the art to a thickness ranging from about 10 to 40 angstroms, and preferably about 15 to 30 angstroms.

Artificial exchange layer 22 functions as an intermediate layer between pinned layer 18 and reference layer 26. Generally, artificial exchange layer 22 provides a medium for the exchange of electrons and antiferromagnetic coupling between layers 18 and 26. The exchange layer 22 may comprise any material, which has properties of a nonmagnetic metal such as copper, chromium, silver, gold, rhodium (Rh), ruthenium (Ru), or alloys thereof. Preferably, the exchange layer 22 comprises ruthenium which has been sputter deposited to a thickness of about 5 to 15 angstroms and preferably about 9 angstroms.

Reference layer 26 has a composition and thickness substantially similar to pinned layer 18 and functions to provide a fixed orientation to the spin valve stack. In order to function as a spin valve, the reference layer 26 has a magnetic orientation that is opposite to the magnetic orientation of the pinned layer 18 as a result of the antiferromagnetic coupling. This allows for the orientation of layer 26 to be fixed.

The intermediate portion 6 of the stack 2 functions to separate the lower 4 and upper 8 portions of the stack and to function as the free layer of spin valve 2. Generally, the intermediate portion 6 of the stack comprises one or more spacer layers 30, 38 and one or more free layers 34.

The spacer layers 30 and 38 function to isolate or insulate the free layer 34 from the pinned and reference layers in the respective upper 8 and lower 4 portions of the stack 2. To this end, the spacer layers 30 and 38 may comprise any non-magnetic electrically conductive material that magnetically insulates the free layer 34. Nonmagnetic materials such as copper, silver, gold and alloys thereof may be used for this layer. One preferred material is copper or alloys of copper, which may be sputter deposited under low power to a thickness of about 15 to 35 angstroms and preferably about 20 angstroms.

Sputter deposition of spacer layers 30 and 38 is conducted in a similar manner as the deposition of the other layers. However, instead of a noble gas atmosphere being introduced at the start of deposition, a mixture of a noble gas and oxgen is introduced upon deposition. Preferably, a mixture of argon and oxygen is utilized.

Exemplary conditions for sputter deposition of spacer layer 30 and 38 are low power (30 W or lower), a pressure of about 0.5 to 20 mTorr, ambient temperature, about 10 to 50 seconds (depending on the desired thickness and deposition rate utilized). Generally, the oxygen has a partial pressure of from about 1 nanoTorr to 50 μTorr at a total pressure of 2 mTorr. The concentration of oxygen can also be expressed as ranging from about 0.5 to 25,000 ppm of the total pressure. Preferably spacer layers 30 and 38 are deposited with an oxygen partial pressure of about 16 μTorr at a total pressure of 2 mTorr oxygen and argon (8,000 ppm), for about 30 seconds (depending on the desired thickness and deposition rate).

The free layer 34 may be comprised of a single or of multiple layers. Generally, the free layer 34 functions to monitor an externally applied magnetic field. Accordingly, when the stack is biased, the free layer 34 will follow the orientation of the resulting magnetic field. The free layer 34 may comprise any material that is a soft magnetic material and may be a mono- or tri-layer. Exemplary materials include nickel, cobalt, iron, and alloys thereof. Preferably, the free layer 34 comprises a tri-layer, which starts with a first layer of cobalt and iron in a ratio of 90:10, a second layer of nickel and iron in a ratio of 85:15 and a third layer of cobalt and iron in a ratio of 90:10. The free layer 34 may be deposited through sputter deposition to a thickness of about 10 to 150 angstroms, preferably about 20 to 30 angstroms.

It is thought that the oxygen present during deposition of the spacer layers 30 and 38 function to smooth the interface between the spacer layers 30 and 38 and the free layer 34. This provides for the reduction of interlayer coupling between the free and reference layer, which is thought to improve sensitivity of spin valve stack 21. The reduction of interlayer coupling also allows the thickness of spacer layers 30 and 38 to be reduced. A thinner spacer layer also improves the GMR effect, which increases sensitivity and decreases the magnetic field that can be detected.

Turning to the upper portion 8 of this embodiment of the invention, reference layer 42, exchange layer 46, and pinned layer 50 may be composed of the same or similar materials and fabricated in the same manner as pinned layer 18, exchange layer 22, and reference layer 26 in the lower portion 4 of this embodiment of the invention. Reference layer 42, exchange layer 46, and pinned layer 50 of the upper portion 8 of this embodiment of the invention function in a similar or the same manner as in the lower portion 4 of the stack 2 with the magnetic orientation of pinned layer 50 being set by antiferromagnetic layer 54. Here again, antiferromagnetic layer 54 may be composed of the same or similar materials as antiferromagnetic layer 14 in the lower portion 4 of the stack 2.

The cap layer 58 functions to structurally protect the device both during fabrication and during operation. Generally, the cap layer 58 is nonmagnetic so as not to affect the electromagnetic operation of the stack 2. Any material that does not have a prevalent magnetic character may be used to form the cap layer 58 such as tantalum, tantalum nitride (TaN), nickel, iron, chromium, as well as mixtures and alloys thereof. The cap layer 58 may be sputter deposited to a thickness of about 30 to 200 angstroms, preferably about 50 angstroms.

The stack 2 of the invention may, if necessary, be annealed after all layers are deposited. Any known process of annealing may be utilized to fabricate a device 2 of the invention. The step of annealing is undertaken in a magnetic field of greater than about 0.5 Tesla, preferably about 1 Tesla. Preferably, the annealing is done at a temperature of about 230° C. to about 350° C. for about 1 to 10 hours.

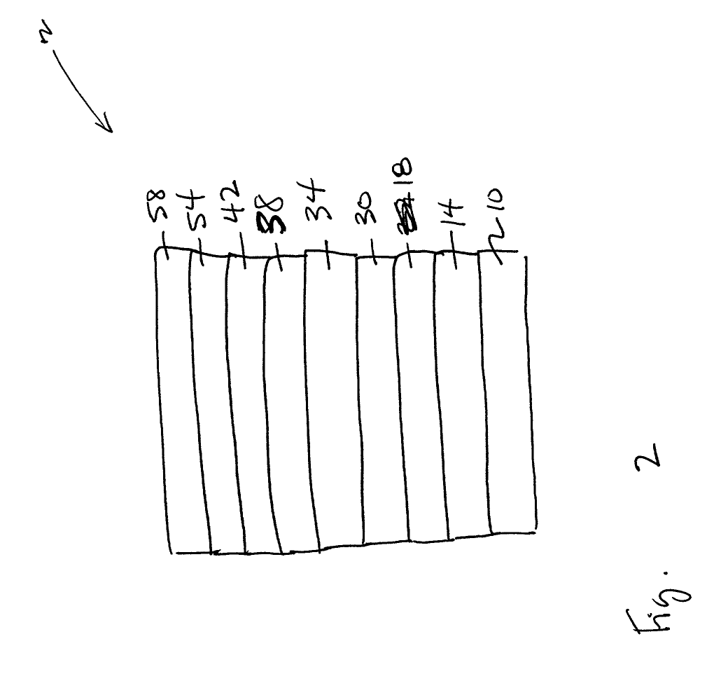

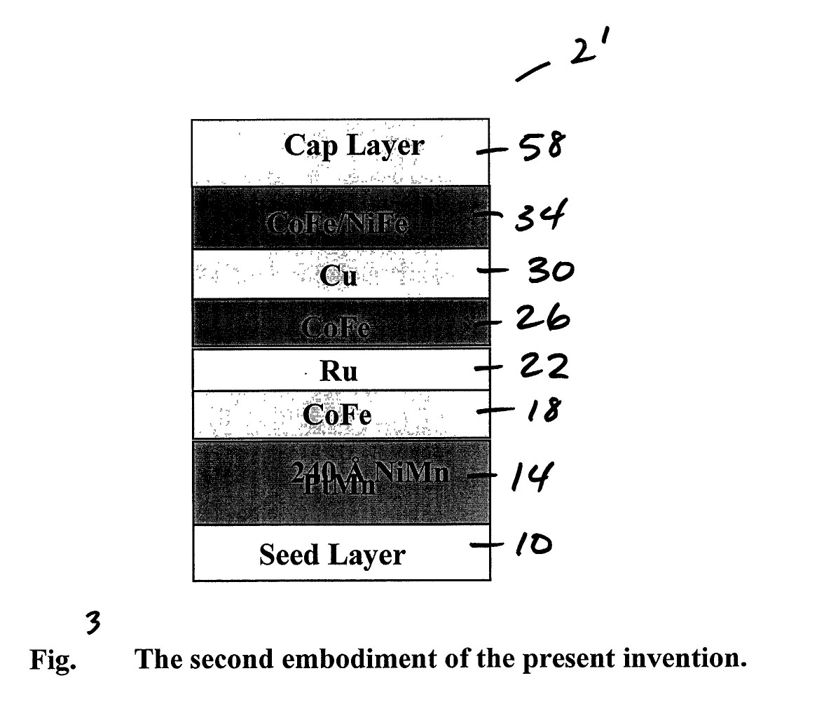

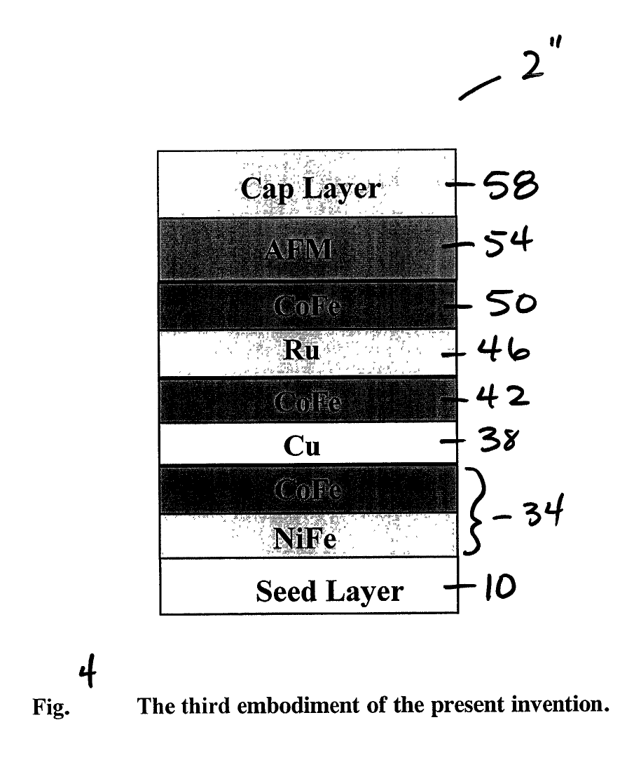

Another embodiment of the invention, depicted in FIG. 2, eliminates the exchange layer 22 and reference layer 26 from the stack 2. By eliminating exchange layer 22 and reference layer 26, a stack with a very small net magnetism is produced. This allows for a stack 2 that is easier to switch with a lower magnetic field. Other embodiments of the invention (for example, those depicted and discussed in reference to FIGS. 3 and 4) can also be modified in this manner.

Another alternative embodiment of the invention is seen in FIG. 3. This embodiment of the invention is a bottom pinned spin valve sensor. This stack 2′ uses antiferromagnetic layer 14 to fix or pin the direction of the magnetic field in layer 18. Pinned layer 18 then works in conjunction with exchange layer 22 and reference layer 26 in the same manner as described earlier. Free layer 34 is insulated from the pinned and reference layers by spacer layer 30.

A further alternative embodiment of the invention, is illustrated in FIG. 4 which depicts a top pinned spin valve sensor (TSV), 2″. In this embodiment, the free layer 34 is a bilayer of cobalt-iron and nickel-iron, which is insulated from the pinned 50 and reference 42 layers by spacer layer 38. In this instance, the magnetic field of the pinned layer 50 is fixed by the antiferromagnetic layer 54, which is positioned below cap layer 58.

Similarly to the dual spin valve depicted in FIG. 1, the bottom and top pinned spin valve sensors depicted in FIGS. 3 and 4 may be modified to eliminate artificial exchange layer 22 and reference layer 26 as shown in the embodiment of the invention illustrated in FIG. 2.

### WORKING EXAMPLES

Several embodiments of the invention were constructed in order to demonstrate relevant characteristics of the invention. These embodiments and the monitored characteristics are presented below. The following examples are in no way meant to limit the scope of the invention, and are offered for illustrative purposes only.

### Example 1

### Oxygen Partial Pressure

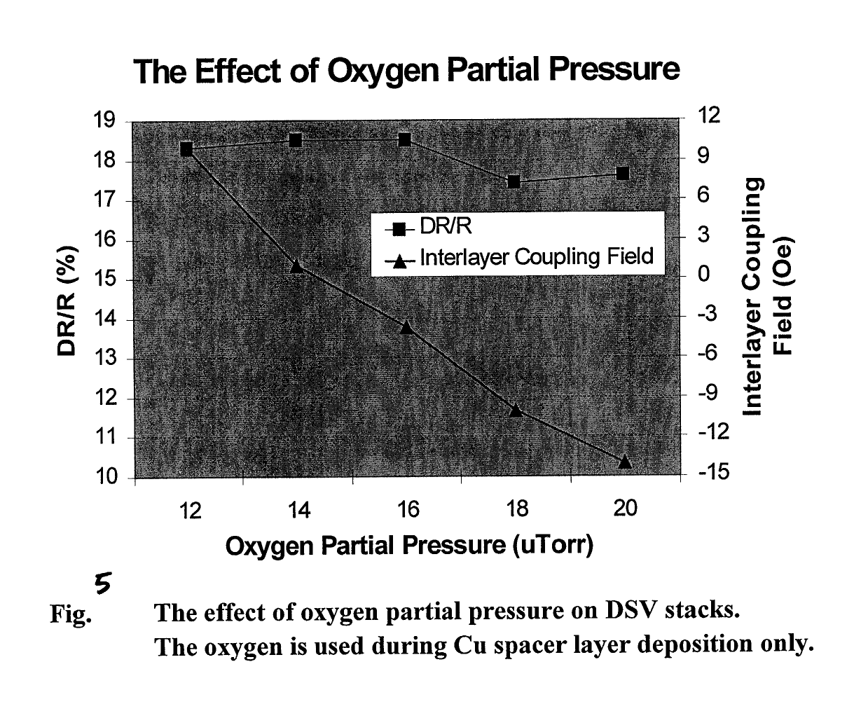

Dual spin valves (DSV) were fabricated in accordance with one aspect of the invention. Five (5) DSVs were constructed with varying levels of oxygen present during deposition of spacer layers 30 and 38. Results of the DR/R and interlayer coupling of these spin valves can be seen in FIG. 5.

An optimum level of oxygen partial pressure of 16 μTorr (at a total pressure of 2 mTorr) was found to maintain DR/R over 18% while at the same time reducing the interlayer coupling field to −4 Oe.

### Example 2

### Copper Spacer Layer Thickness

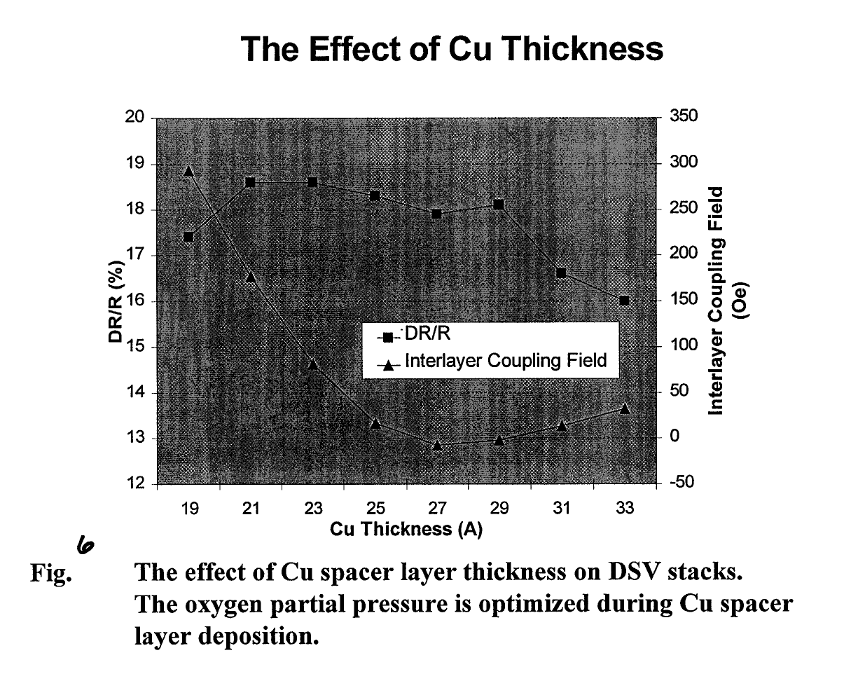

DSVs were fabricated in accordance with one aspect of the invention. Eight (8) DSVs were fabricated with varying thicknesses of copper in spacer layers 30 and 38 with an optimal partial pressure of oxygen. The thickness of the copper ranged from 19 to 33 angstroms thick. The results of testing the DR/R and interlayer coupling field of the various DSVs in accordance with the invention can be seen in FIG. 6.

As can be seen, by combining the optimized oxygen and argon gas levels (determined from the results in Example 1) spacer layer thickness can be increased to result in a diminished interlayer coupling. The optimal DRIR under this study seemed to be reached between about 20 and 25 angstroms. The results seemed to show that orange peel coupling field was suppressed.

### Example 3

### DR/R of DSVs Fabricated With and Without Oxygen

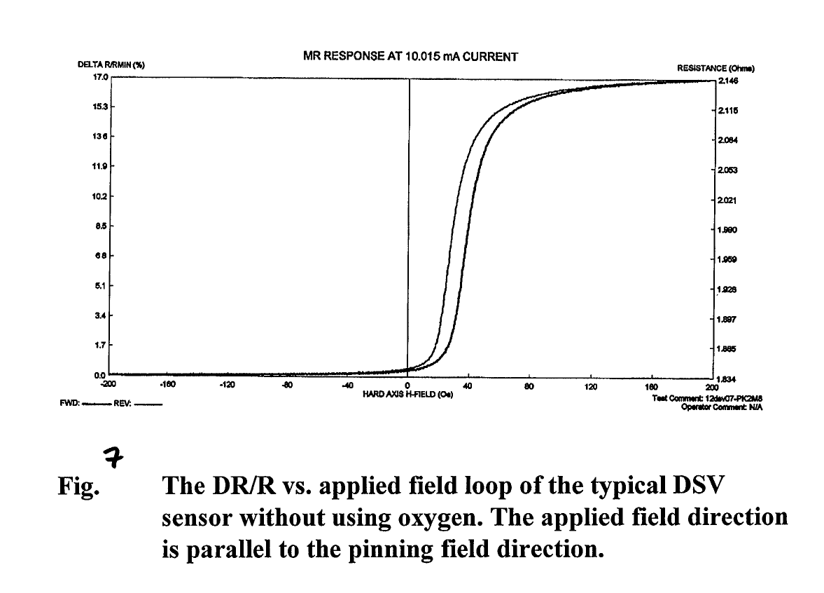

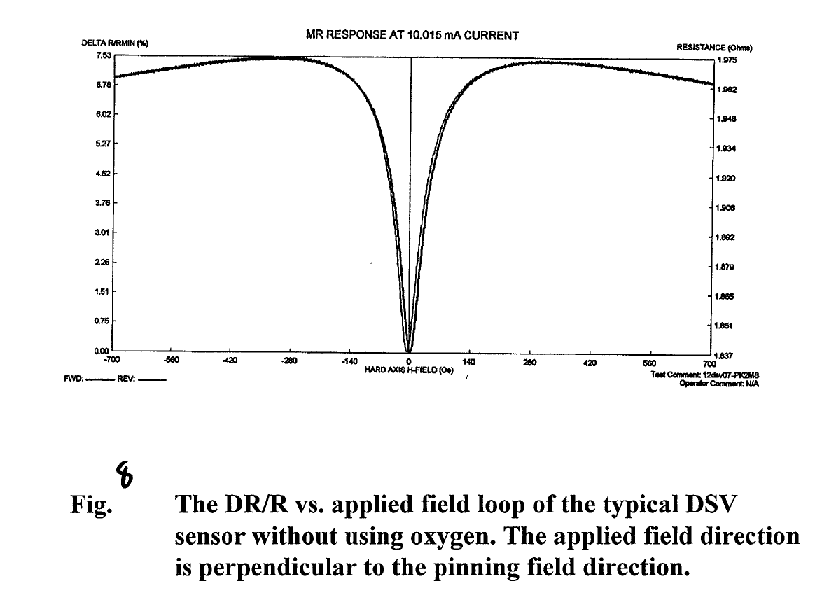

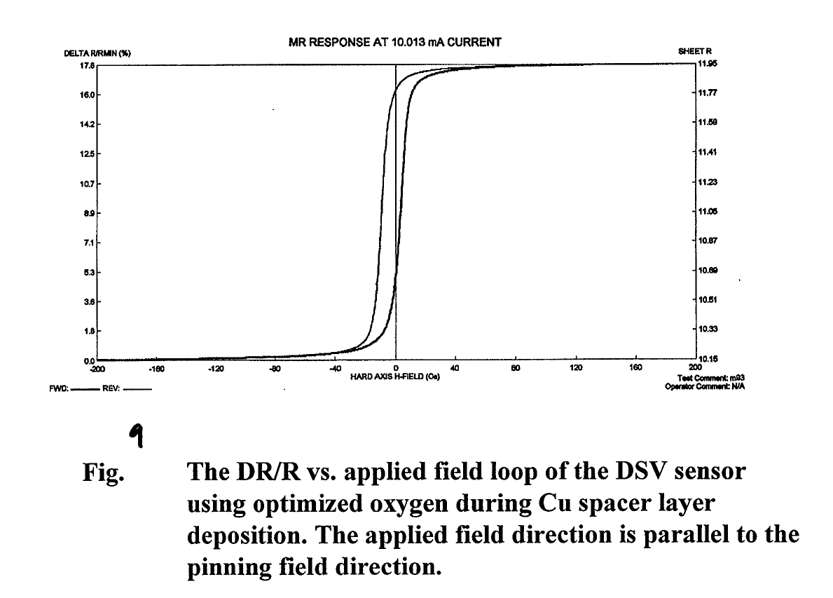

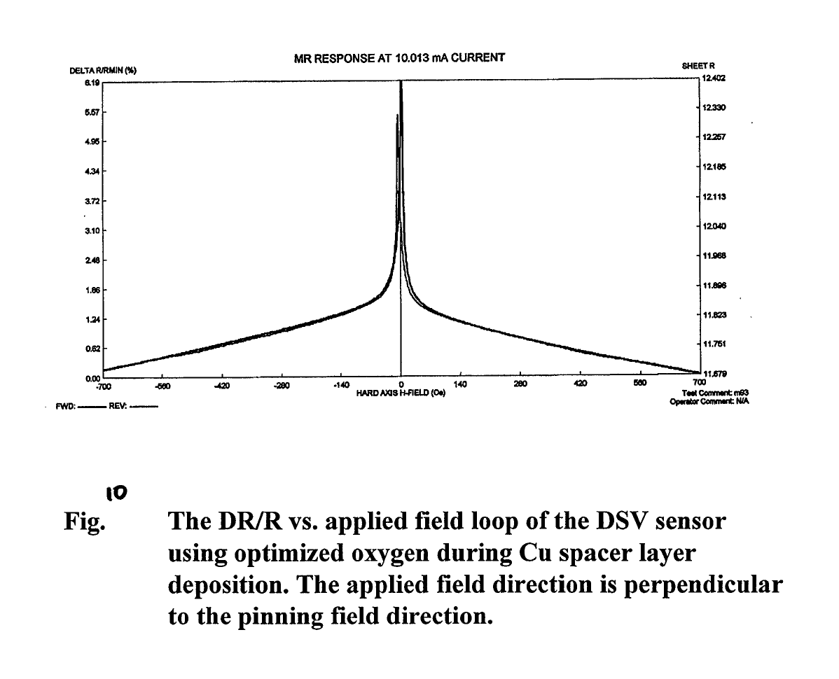

FIGS. 7 and 8 depict conventional DSVs, those fabricated without oxygen present during deposition of spacer layers 30 and 38, with applied fields positioned in a direction parallel and perpendicular, respectively. FIGS. 9 and 10 depict DSVs in accordance with the invention, fabricated with oxygen present during deposition of spacer layers 30 and 38, with applied fields positioned in a direction parallel and perpendicular, respectively. Table 1 below compares the results of the DSVs when the applied field direction is parallel to the pinning field direction.

TABLE 1

| | Interlayer Coupling | |
|---|---|---|
| | Field | Sensitivity |
| DR/R | (Oe) | (mOhms/Oe) |
| 17.5% | 35 | 13 |
| 18.5% | −3 | 33 |

As can be seen, from Table 1, DR/R increases, interlayer coupling decreases, and sensitivity increases when oxygen is present during the deposition of spacer layers.

### Example 4

### DR/R of BSVs Fabricated With and Without Oxygen

A bottom spin valve (BSV) was fabricated with (in accordance with the invention) and without (according to a method of the prior art) oxygen present during deposition of copper spacer layer 38.

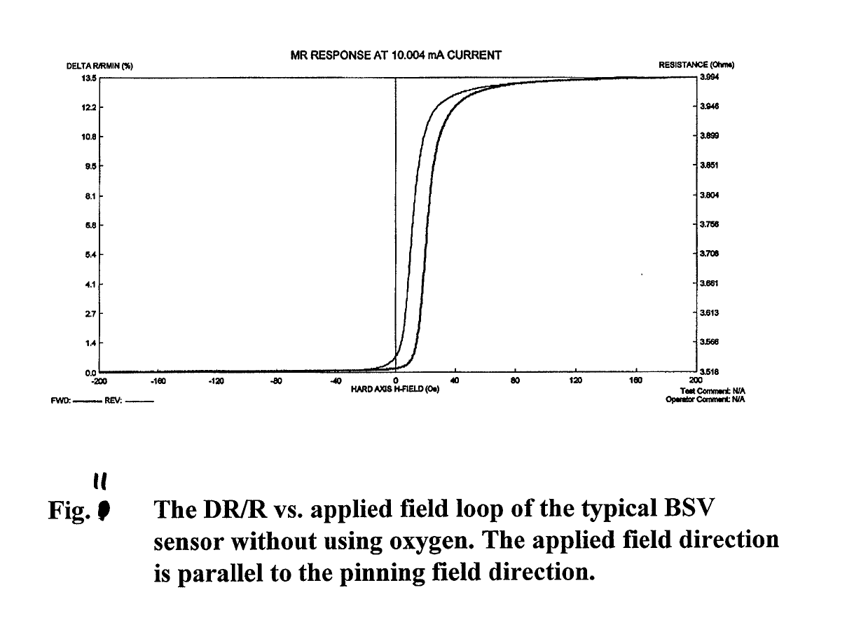

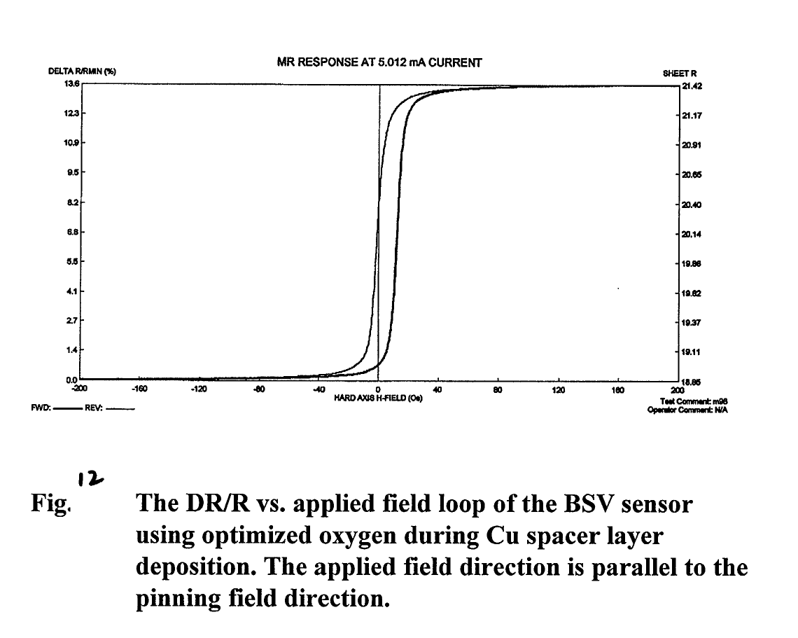

FIGS. 11 and 12 illustrate the results of applying a field parallel to the pinning field direction of the two spin valves. Table 2, below, compares the DR/R, interlayer coupling and sensitivity in the two spin valves (conventional—FIG. 11, in accordance with the invention—FIG. 12).

TABLE 2

| | Interlayer Coupling | Sensitivity |
|---|---|---|
| DR/R | Field (Oe) | (mOhms/Oe) |
| 13.5% | 150 | 30 |
| 13.9% | 5 | 50 |

As can be seen from Table 2, DR/R increases, interlayer coupling decreases, and sensitivity increases when oxygen is present during the deposition of spacer layers.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method of manufacturing a spin valve sensor, the method comprising the steps of:
(a) depositing a non-magnetic electrically conductive material on said pinned layer to form a spacer layer in an environment comprising oxygen gas; and
(b) depositing a ferromagnetic free layer on said spacer layer in an environment comprising oxygen.

2. The method of claim 1, wherein said free layer is deposited prior to deposition of said pinned layer.

3. The method of claim 1, wherein said antiferromagnetic material is a metal oxide or metal alloy selected from the group of platinum, manganese, nickel, chromium, iridium, rhodium, paladium, copper, ruthenium, iron and mixtures therof.

4. The method of claim 1, wherein said antiferromagnetic material comprises platinum and manganese having a ratio of from about 40:60 to 60:40.

5. The method of claim 4, wherein said antiferromagnetic material has a thickness of about 150 angstroms.

6. The method of claim 1, wherein said ferromagnetic pinned layer comprises a highly magnetic metal selected from the group of cobalt, iron, nickel, chromium, platinum, or tantalum, and mixtures thereof.

7. The method of claim 6, wherein said ferrogmagnetic pinned layer highly magnetic metal comprises cobalt and iron having a ratio of from about 80:20 to 95:5.

8. The method of claim 1, wherein said spacer layer non-magnetic electrically conductive material is chosen from the group of copper, silver, gold, and alloys thereof.

9. The method of claim 8, wherein said non-magnetic electrically conductive material comprises copper or a copper alloy having a thickness of from about 15 to 35 angstroms.

10. The method of claim 1, wherein said spacer layer is deposited in an atmosphere having from about 0.5 to 25,000 ppm oxygen.

11. The method of claim 10, wherein said spacer layer is deposited in an atomsphere of about 8,000 ppm oxygen.

12. The method of claim 1; wherein said ferromagnetic free layer comprises at least one soft magnetic material selected from the group of nickel, cobalt, iron, and alloys thereof.

13. The method of claim 12, wherein said ferromagnetic free layer comprises
(c) a first layer of cobalt and iron;
(d) a second layer of nickel and iron; and
(e) a third layer of cobalt and iron.

14. The method of claim 13, wherein said ferromagnetic free layer comprises
(f) a first layer of cobalt and iron at a ratio of about 90:10;
(g) a second layer of nickel and iron at a ratio of about 85:15; and
(h) a third layer of cobalt and iron at a ratio of about 90:10.
wherein said ferromagnetic free layer has a thickness of from about 10 to 150 angstroms.

15. The method of claim 1, further comprising depositing a reference layer between said ferromagnetic pinned layer and said spacer layer, wherein said reference layer comprises a highly magnetic metal chosen from the group of cobalt, iron, nickel, chromium, platinum, or tantalum, combinations thereof.

16. The method of claim 15, wherein said highly magnetic metal comprises cobalt and iron in a ratio of from about 80:20 to 95:5.

17. The method of claim 14, further comprising depositing an artificial exchange layer on said ferromagnetic pinned layer before deposition of said reference layer, said artificial exchange layer comprising a material having the properties of a nonmagnetic metal chosen from the group of copper, chromium, silver, gold, rhodium, ruthenium, and alloys thereof.

18. The method of claim 17, wherein said material comprises ruthenium and said artificial exchange layer has a thickness of from about 5 to 15 angstroms.

19. The method of claim 1, further comprising annealing said spin valve sensor in the presence of a magnetic field at a temperature of from about 230° C. to 350° C., for a period of about 1 to 10 hours, with an applied magnetic field of at least 0.5 Tesla.

20. The method of claim 1 further comprising depositing a cap layer on said free layer, said cap layer having a thickness from about 30 to 200 angstroms.

21. A bottom pinned spin valve resulting from the method of claim 1.

22. A top pinned spin valve resulting from the method of claim 1.

23. A dual spin valve resulting from the method of claim 1.

24. A spin valve sensor comprising a spacer layer, wherein said spacer layer comprises a non-magnetic electrically conductive material and oxygen.

25. The spin valve sensor of claim 24, wherein said non-magnetic electrically conductive material is chosen from the group of copper, silver, gold and alloys thereof.

26. The spin valve sensor of claim 25, wherein said non-magnetic electrically conductive material comprises copper.

27. The spin valve sensor of claim 26, wherein said spin valve sensor is a bottom pinned spin valve.

28. The spin valve sensor of claim 26, wherein said spin valve sensor is a top pinned spin valve.

29. The spin valve sensor of claim 26, wherein said spin valve sensor is a dual spin valve.
